(19) United States
(12) Patent Application Publication
(10) Pub. No.: US 2002/0031700 A1
(43) Pub. Date: Mar. 14, 2002

(54) High current low resistance double latching battery switch

(75) Inventors: William J. Wruck, Whitefish Bay, WI (US); Majid Taghikhani, Franklin, WI (US); Wen-Hong Kao, Brown Deer, WI (US); Edward N. Mrotek, Grafton, WI (US); Michael L. Thomposon, East Troy, WI (US); Guy L. Pfeifer, Milwaukee, WI (US); William Berry, Menomonee Falls, WI (US); Nick Rajnovic, West Allis, WI (US); James R. Krenz, Milwaukee, WI (US); Dennis Nykiel, Milwaukee, WI (US)

Correspondence Address: QUARLES & BRADY LLP, 411 E. WISCONSIN AVENUE, SUITE 2040, MILWAUKEE, WI, 53202-4497, US

(73) Assignee: Johnson Controls Technology Company

(21) Appl. No.: 09/912,091

(22) Filed: Jul. 24, 2001

Related U.S. Application Data
(60) Provisional application No. 60/222,524, filed on Aug. 2, 2000.

(51) Int. Cl. H01M 2/28; H01M 2/34

(52) U.S. Cl. 429/61; 429/7; 429/152; 429/8

(57) ABSTRACT

A switch for controlling the supply of current from a battery cell in a cell cavity to a battery terminal in a battery casing is disclosed. The switch includes a mounting base, a first buss bar connected to the mounting base and connectable to the battery cell, a second buss bar connected to the mounting base and connectable to the battery terminal, and a relay having open and closed positions. The relay includes a third buss bar that places the first buss bar and the second buss bar in contact to provide current from the battery cell to the battery terminal when the relay is in the closed position. The relay is moved into a latched open position when a first winding of a coil of the relay is energized by electricity, and is moved back into a latched closed position when a second winding of the coil is energized.

### CROSS REFERENCES TO RELATED APPLICATIONS

This application claims the benefit of U.S. Provisional Patent Application No. 60/222,524 filed Aug. 2, 2000.

### BACKGROUND OF THE INVENTION

1. Field of the Invention

This invention relates to switches for controlling a supply of electric current from a battery cell in a battery cell cavity to a battery terminal in a battery casing, and more particularly to a high current, low resistance latching anti-theft battery switch for use in vehicle batteries.

2. Description of the Related Art

Motor vehicles typically include a lead-acid storage battery to power an electric starter motor and to run vehicle accessories, such as lights, clocks, and radios. When choosing a correct battery for a motor vehicle, an automotive engineer generally looks at the ability of a battery to power the starter to enable minimum starting speed under very cold conditions. As a result, various accepted performance ratings have been developed for automotive batteries so that a person choosing a battery can match a battery to a vehicle.

In the lead-acid automotive battery field, the Battery Council International, an association of battery manufacturers, has developed performance ratings that can be used to compare batteries. For example, cold cranking performance is a rating used to describe battery high rate discharge capability at low temperature (0° F. or −18° C.). Cold cranking performance is the discharge load in amperes that a new, fully charged battery at 0° F. (−18° C.) can continuously deliver for 30 seconds and maintain a battery terminal voltage equal to or higher than 1.20 volts per cell (7.2 volts for a typical 12 volt automotive battery). Battery manufacturers report this performance rating as cold cranking amps or “CCA”, and often stamp this rating on batteries. Typical values for cold cranking amps for a lead-acid automobile battery are about 300 to 1,000 amperes. Cold cranking amps have become a widely accepted performance rating for motor vehicle batteries, and are used as a product comparison guide by automotive engineers and consumers purchasing replacement batteries. Battery manufacturers also use cold cranking performance ratings as a quality control measure for newly manufactured batteries, and often seek to develop batteries with higher and higher cold cranking performance ratings in an effort to meet vehicle manufacturer and replacement battery retailer demands for more powerful batteries.

While battery manufacturers have worked to develop batteries with higher performance ratings for decades, there have been recent efforts in the automotive battery manufacturing field to develop batteries that can perform additional functions in a vehicle. For instance, there have been significant advancements in the use of an automobile battery as a vehicle anti-theft device or as part of a vehicle anti-theft system.

Various modifications are made to a standard automobile battery so that the automobile battery can assist in the prevention of automobile theft. For example, U.S. Pat. No. 5,498,486 discloses an anti-theft automobile battery wherein a usual battery having usual positive and negative battery terminal posts is modified by installing two additional dummy terminals near the two usual positive and negative battery posts. The negative “dummy” is an electrical contact with the usual negative battery post and the positive “dummy” is connected through a switch to the usual positive battery post. The dummy positive battery post is connected to the starter and the usual positive post is connected to various other loads. These usual posts are then covered by a lid leaving only the positive and negative dummy posts exposed. The switch is placed between the positive dummy terminal and the positive covered battery post to open or close connection between them by a relay operation. A relay controller operates between an enable circuit that permits current to travel between the positive dummy and usual positive post and an inhibit circuit that prevents current from so traveling. The relay controller is activated by a user keypad in the automobile and connected to the controller at the battery.

In PCT International Publication No. WO 95/35228, there is disclosed a motor vehicle starter battery having semiconductor switches connected in parallel between the middle battery cells. The switches are controlled by a processor which can receive signals from the exterior, such as rf-signals received by a receiver, for allowing a high but not too high current for powering a starter motor from the battery. In other cases, only small currents can be drawn from the battery for powering a clock, illumination, etc. The processor also monitors the charge state and can block small currents when there is too little charge left whereby a sufficient charge can be left for starting the motor. The switches are located inside the battery in a conducting contact with a metal plate, which is mounted directly on a terminal of one of the middle battery cells. On the adjacent terminal of the other one of the central cells a conducting plate may be mounted, which is isolated from the first plate. To this second plate, at areas located adjacent to an edge next to the first plate, the switches are connected electrically through connection wires.

In PCT International Publication No. WO 93/15935, there is disclosed an anti-theft system for a motor vehicle having a battery supplying electrical power to enable the vehicle to operate, the battery having a built-in remotely-operable switch to interrupt or limit current flow between one of the battery terminals and the battery cells. The battery is of the conventional type comprising a casing containing a plurality of electrical cells and having external positive and negative terminals. The battery cells are connected to one of the terminals directly and to the other terminal through switching means within the casing, the switching means being arranged to close the circuit between the cells and one of the terminals in response to a control signal from an external device. The switching means also includes a bypass circuit to provide low currents to vehicle accessories when the circuit between the cells and one of the terminals is open.

U.S. Pat. No. 5,963,018 describes another anti-theft vehicle battery in which an inhibitor is connected between the positive battery cells in the battery and the usual positive battery terminal post that extends out of the battery. Also connected between the positive battery cells and the positive battery terminal is the combination of a resistor and a thermal fuse. A solenoid switch which is controlled by a user activated microprocessor is used to open or close the inhibitor circuit path between the positive battery cells and the positive battery terminal. When the switch is closed, full voltage is applied to the starter switch to turn over the vehicle starter motor and start the automobile motor. When the switch is open, a limited amount of current is supplied to the vehicle electrical system, i.e., less than is needed to turn over the starter motor. The user opens or closes the switch by way of a keypad that initiates microprocessor control of the switch.

While the aforementioned anti-theft batteries can provide certain protection against vehicle theft, these batteries do have drawbacks. For example, these systems often require two separate circuit paths between the battery and vehicle electrical system components. Typically, these systems have a first circuit path between the battery and the starter motor and a second circuit path between the battery and vehicle accessories. When arming the anti-theft system of these batteries, the first circuit path between the battery and the starter motor is opened and the second circuit path between the battery and the vehicle accessories is maintained. It is believed that these dual circuit paths used in known anti-theft batteries add to the complexity and cost of these systems. It would be desirable to provide an anti-theft battery having a single circuit path between the battery and the vehicle starter and accessories.

Known anti-theft batteries also often include switches that require a continuous electrical current in order to keep the switch in an open or closed position. This can be a disadvantage in that a constant drain is kept on the battery. What is needed is a switch for an anti-theft battery than can be latched into an open or closed position without the need for a continuous supply of electric current.

In addition, known anti-theft batteries often include switches that introduce high levels of resistance into a circuit path in the battery. For example, switches that are placed in a circuit path between battery cells and a battery terminal can increase the resistance between the battery cells and the battery terminal. This increased resistance can significantly affect the results of battery performance tests such as the cold cranking tests described above. This can be a significant advantage in that a standard automobile battery may be marketed with one cold cranking amps rating, and then when the battery modified to include anti-theft features, the battery is unable to meet the established cold cranking amps rating. The battery manufacturer is then faced with the dilemma of either redesigning the anti-theft battery to increase cold cranking ratings or dropping the cold cranking amps rating, an option that may be resisted by customers. What is needed then is a battery anti-theft switch that can be installed in a battery without significantly affecting battery performance tests such as a cold cranking test. Also, there is a need for a low resistance battery switch for anti-theft batteries that can withstand the high discharge currents used in such battery performance tests.

Thus, it can be seen that there is a need for an anti-theft battery switch that provides a single circuit path between the battery and the vehicle starter and accessories, that can be latched into an open or closed position without the need for a continuous supply of electric current, that has a low resistance, and that can withstand the high discharge currents used in battery performance tests. Preferably, each of the needs above can be satisfied by an anti-theft battery switch that can be fitted into existing battery containers.

### SUMMARY OF THE INVENTION

The foregoing needs are met by a switch for controlling the supply of current from a battery cell in a cell cavity to a battery terminal in a battery casing. The switch includes a mounting base, a first buss bar connected to the mounting base and suitable for connection to the battery cell, a second buss bar connected to the mounting base and suitable for connection to the battery terminal, and a relay having an open and a closed position, the relay including a third buss bar such that when the relay is in the closed position, the third buss bar places the first buss bar and the second buss bar in electrical communication to provide current from the battery cell to the battery terminal.

The switch is suitable for high current battery applications because the third buss bar is preferably formed from a copper alloy and is configured to keep the temperature of the third buss bar at or below 100° C. during current flows of 800 amps or greater. The switch also minimizes degradation of battery performance as the electrical resistance as measured between a first contact surface of the first buss bar and a second contact surface of the second buss bar, when the third buss bar contacts the first contact surface and the second contact surface in the closed position of the relay, is less than 0.3 milliohms at 200 amps or greater current. The relay includes a coil suitable for connection to a source of electric current and a plunger slidably disposed within the interior of the coil. The third buss bar is mounted to the plunger, and the plunger is moved into a latched open position when a first winding of the coil is energized by a pulse of electric current, and is moved back into a latched closed position when a second winding of the coil is energized by a pulse of electric current. The plunger remains in the latched open or latched closed position without the need for a continued supply of electric current.

The switch is particularly useful when employed in a battery for supplying electric power to a starter motor and to electrical loads in a vehicle. In one form, the battery includes a battery casing including a container and a cover. The battery casing has an external positive terminal and an external negative terminal, and the container has a plurality of cell cavities. In each cell cavity, there is disposed a battery cell containing at least one negative plate, at least one positive plate, and a separator between adjacent negative and positive plates. A first circuit path is provided between one of the negative or positive terminal and a first set of plates of common polarity in one battery cell, and a second circuit path is provided between the other of the positive or negative terminal and a second set of plates of opposite common polarity in another battery cell. The second circuit path is the only electrical path between the second set of plates and the other of the positive or negative terminal. The battery further includes a switch according to the invention arranged in the second circuit path. The switch has a normally closed position and an open position, and moves into the open position in response to a pulse signal from a controller in electrical communication with the battery and the switch.

It is therefore an advantage of the present invention to provide an anti-theft battery switch that provides a single circuit path between the battery and the vehicle starter and accessories.

It is another advantage of the present invention to provide an anti-theft battery switch that can be latched into an open or closed position without the need for a continuous supply of electric current from the battery.

It is still another advantage of the present invention to provide an anti-theft battery switch that has a low resistance.

It is yet another advantage of the present invention to provide an anti-theft battery switch that can withstand the high discharge currents used in battery performance tests.

It is another advantage of the present invention to provide an anti-theft battery switch that can be fitted into existing battery containers.

### BRIEF DESCRIPTION OF THE DRAWINGS

These and other features, aspects, and advantages of the present invention will become better understood upon consideration of the following detailed description, appended claims and accompanying drawings where:

FIG. 1 is a perspective view of a battery in accordance with the present invention;

FIG. 2 is a top plan view of the battery of FIG. 1 with the cover plate removed;

FIG. 3 is a cross-sectional view of the battery of FIG. 1 taken along line 3-3 of FIG. 2;

FIG. 4 is an exploded view of a battery switch assembly used in the battery of FIG. 1;

FIG. 5 is a cross-sectional view of the relay of the battery switch assembly of FIG. 4 taken along line 5-5 of FIG. 4 when the relay is in a retracted position;

FIG. 5A is a cross-sectional view of another version of the relay of the battery switch assembly of FIG. 4 taken along line 5-5 of FIG. 4 when the relay is in a retracted position;

FIG. 6 is a cross-sectional view of the relay of the battery switch assembly of FIG. 4 taken along line 5-5 of FIG. 4 when the relay is in an extended position;

FIG. 6A is a cross-sectional view of another version of the relay of the battery switch assembly of FIG. 4 taken along line 5-5 of FIG. 4 when the relay is in an extended position;

FIG. 7 is front elevational view of the battery switch assembly of FIG. 4 when the relay is in an extended (closed) position;

FIG. 8 is rear elevational view of the battery switch assembly of FIG. 4 when the relay is in an extended (closed) position;

FIG. 9 is a cross-sectional view of the battery switch assembly of FIG. 4 taken along line 9-9 of FIG. 7; and

FIG. 10 is a schematic block diagram of a vehicle electrical system using a battery in accordance with the present invention.

It should be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted. It should be understood, of course, that the invention is not necessarily limited to the particular embodiments illustrated herein.

Like reference numerals will be used to refer to like or similar parts from Figure to Figure in the following description of the drawings.

### DETAILED DESCRIPTION OF THE INVENTION

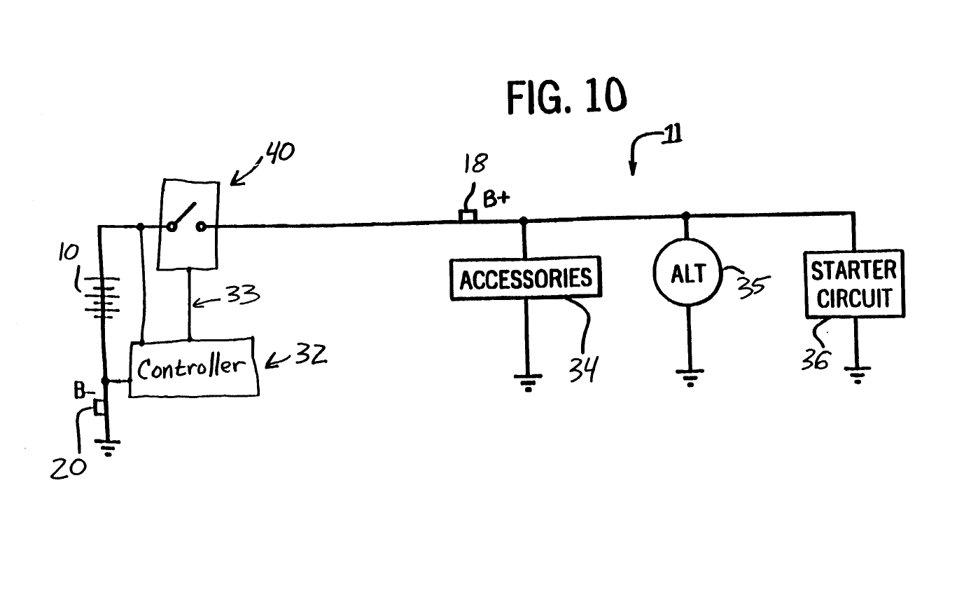

Looking first at FIG. 10, there is shown a schematic block diagram of a vehicle electrical system 11 of a vehicle (not shown) that includes a vehicle battery 10 in accordance with the present invention for storing electrical power, a starter circuit 36, an alternator 35 and electrical accessories 34. The battery 10 is a typical 12-volt lead acid battery of the type used in most vehicles, and its operation and configuration is well known in the art. The battery 10 includes a positive battery terminal post 18 that is connected to a positive battery cable (not shown) and a negative battery terminal post 20 that is connected to a negative battery cable (not shown). The voltage of the vehicle electrical system 11 is provided at the positive terminal post 18. Each of the starter circuit 36, the alternator 35 and the electrical accessories 34 are connected in parallel with the battery 10. The starter circuit 36 typically would include an ignition switch (not shown) and a starting motor (not shown) which operate to turn a flywheel (not shown) under power from the battery 10 when the ignition switch is closed to start the vehicle engine (not shown). The alternator 35 provides electrical power to the various vehicle electrical systems once the vehicle engine is operating, and recharges the battery 10. The vehicle electrical accessories 34 can be any other electrical device or system in the vehicle, such as headlights, dome light, radio, horn, clock, etc. The operation of the starter circuit 36, the alternator 35 and the electrical accessories 34 are well known in the art.

The vehicle electrical system 11 also includes a controller 32 that is electrically connected via circuit path 33 to a switch assembly 40 that is in a circuit path between the battery cells and the positive terminal post 18. The switch assembly 40 is a normally closed relay switch electrically connected in series with the battery 10. Under certain operating conditions, the controller 32 provides a control signal via path 33 to the switch assembly 40 in order to open the switch and disconnect battery power applied to the starter circuit 36, the alternator 35 and the electrical accessories 34. In one embodiment, the controller 32 and the switch assembly 40 are part of a module that is connected to the battery 10.

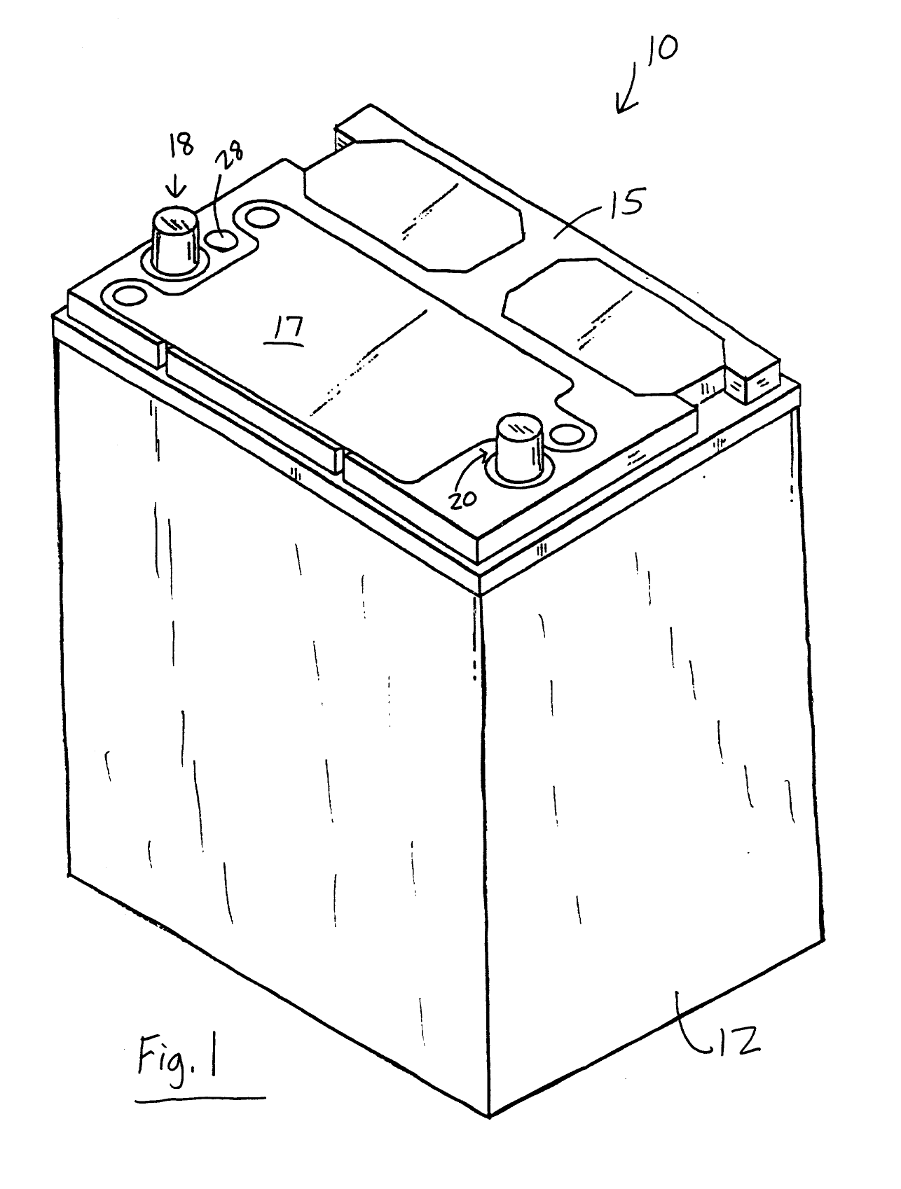

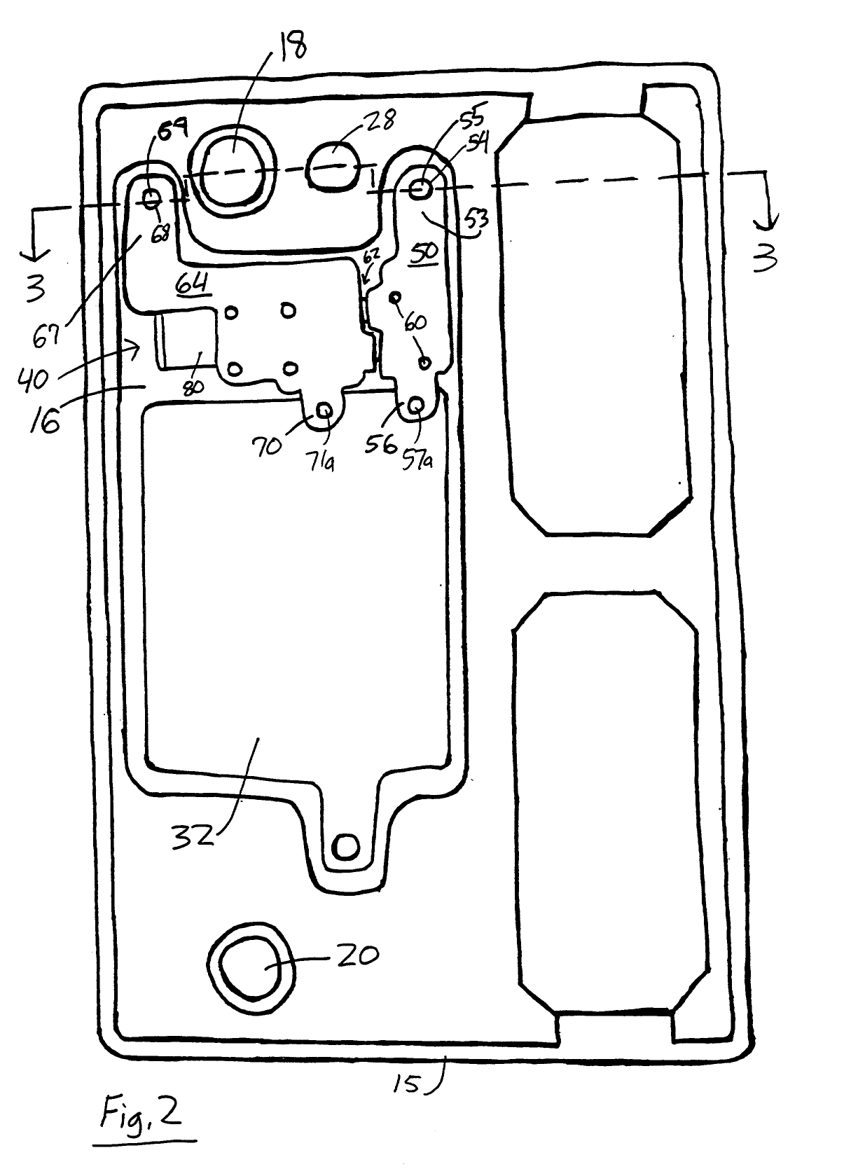

Referring now to FIGS. 1 to 3, a battery 10 in accordance with the present invention is shown. The battery 10 has an appearance virtually identical to a standard vehicle battery. The battery 10 has a casing comprising a container 12 and a cover 15. A positive battery terminal post 18 extends upward from the cover 15 and is typically connected to a positive battery cable (not shown) which is further connected to a starter circuit 36, an alternator 35 and electrical accessories 34 as shown in FIG. 10. A negative battery terminal post 20 also extends upward from the cover 15 and is connected to a negative battery cable (not shown) which is grounded to the vehicle chassis. The cover 15 also includes a cover plate 17 that is used to conceal a controller 32 and a switch assembly 40 that are arranged in a well 16 in the cover 15 (see FIG. 2).

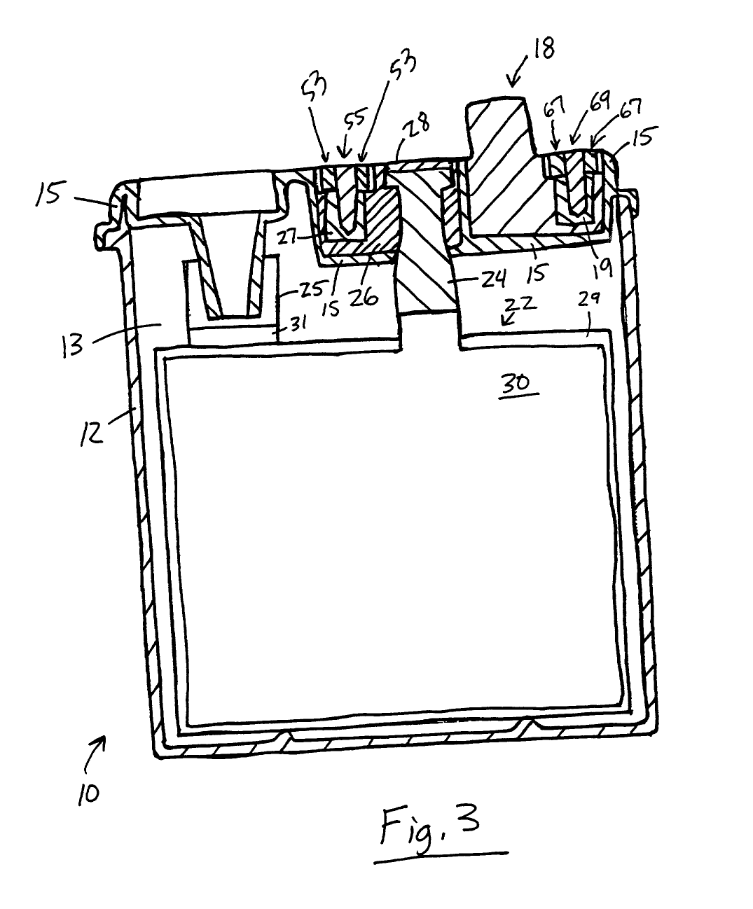

FIG. 3 shows the arrangement of the battery components in an end cell cavity 13 of the battery 10 below the positive terminal 18. As is well known in the art, the container 12 includes a plurality of cell cavities 13 each of which contains a battery cell 22. In the automotive battery field, there will typically be six cell cavities 13, each of which contains a lead acid battery cell 22 having a nominal voltage of 2 volts. The battery cells 22 are connected in series to produce a battery 10 having a 12 volt nominal voltage. Of course, a battery 10 in accordance with the present invention may have any number of cell cavities 13 and associated battery cells 22.

Each battery cell 22 includes a first set of pasted plates 31 having a common negative polarity and a second set of pasted plates 30 having a common positive polarity. The negative plates 31 and the positive plates 30 are separated by separators 29 as is well known in the art. The negative plates 31 in the battery cell shown in FIG. 3 are connected at their upper end by a terminal strap 25 that allows for serial connection to the battery cell in an adjacent cell as is well known. The positive plates 30 in the battery cell 22 of FIG. 3 are connected at their upper end to a lead or lead alloy cell post 24 that forms a portion of a current path to the positive terminal 18 as will be described below. An electrolyte (not shown) is also included in the cell cavity 13.

The current path between the cell post 24 and the positive terminal 18 can be described with reference to FIGS. 2 and 3. When the cover 15 of the battery 10 is sealed to the container 12 during manufacture, the cylindrical cell post 24 is inserted into a mating hole in a lead connector 26 encapsulated on all but an exposed upper surface of the connector 26 within the plastic cover 15 as best shown in FIG. 3. Heat is then applied to the top end of the cell post 24 and the exposed upper surface of the connector 26 to create a weld and thereby form a conductive path between the cell post 24 and the connector 26. A plastic cap 28 is then inserted over the exposed upper surfaces of the connector 26 and the cell post 24. Within the connector 26, there is arranged an internally threaded conductive insert 27. As shown in FIG. 3, the positive terminal 18 is also molded in the plastic cover 15, and also includes an internally threaded conductive insert 19.

Looking now at FIGS. 2 and 3, it can be seen that the switch assembly 40 includes a first conductive buss bar 50, a second conductive buss bar 64, and a relay 80. The relay 80 opens and closes to provide a circuit path between the first buss bar 50 and the second buss bar 64 as will be described below. The first buss bar 50 includes a mounting hole 54 at a first end portion 53, and the second buss bar 64 includes a mounting hole 68 at a first end portion 67. When the switch assembly 40 is installed in the well 16 of the cover 15, the first buss bar 50 is placed in electrical communication with the connector 26 by placing the first end portion 53 of the first buss bar 50 over the connector 26 and threading a fastener 55 into the insert 27 of the connector 26 to provide a secure connection between the connector 26 and the first buss bar 50. Likewise, the second buss bar 64 is placed in electrical communication with the positive terminal 18 by placing the first end portion 67 of the second buss bar 64 over a portion of the positive terminal 18 and threading a fastener 69 into the insert 19 of the positive terminal 18 to provide a secure connection between the connector 26 and the second buss bar 64. Of course, alternative means for creating an electrical connection between the first buss bar 50 and the connector 26 and between the second buss bar 64 and the positive terminal 18, such as welding, are equally effective.

Having described the connection between the cell post 24 and the positive terminal 18 above, the circuit path between the set of positive plates 30 and the positive terminal 18 can now be seen from FIGS. 2 and 3. Current flows from the positive plates 30 through the cell post 24 and into the connector 26. From the connector 26, the current flows into the first end portion 53 of the first buss bar 50. Assuming the relay 80 is in the closed position, current flows from the first buss bar 50 to the second buss bar 64. From the second buss bar 64, current flows from the first end portion 67 of the second buss bar 64 and into the positive terminal 18. The circuit path between the set of positive plates 30 and the positive terminal 18 can be interrupted by opening the relay 80 as will be described below.

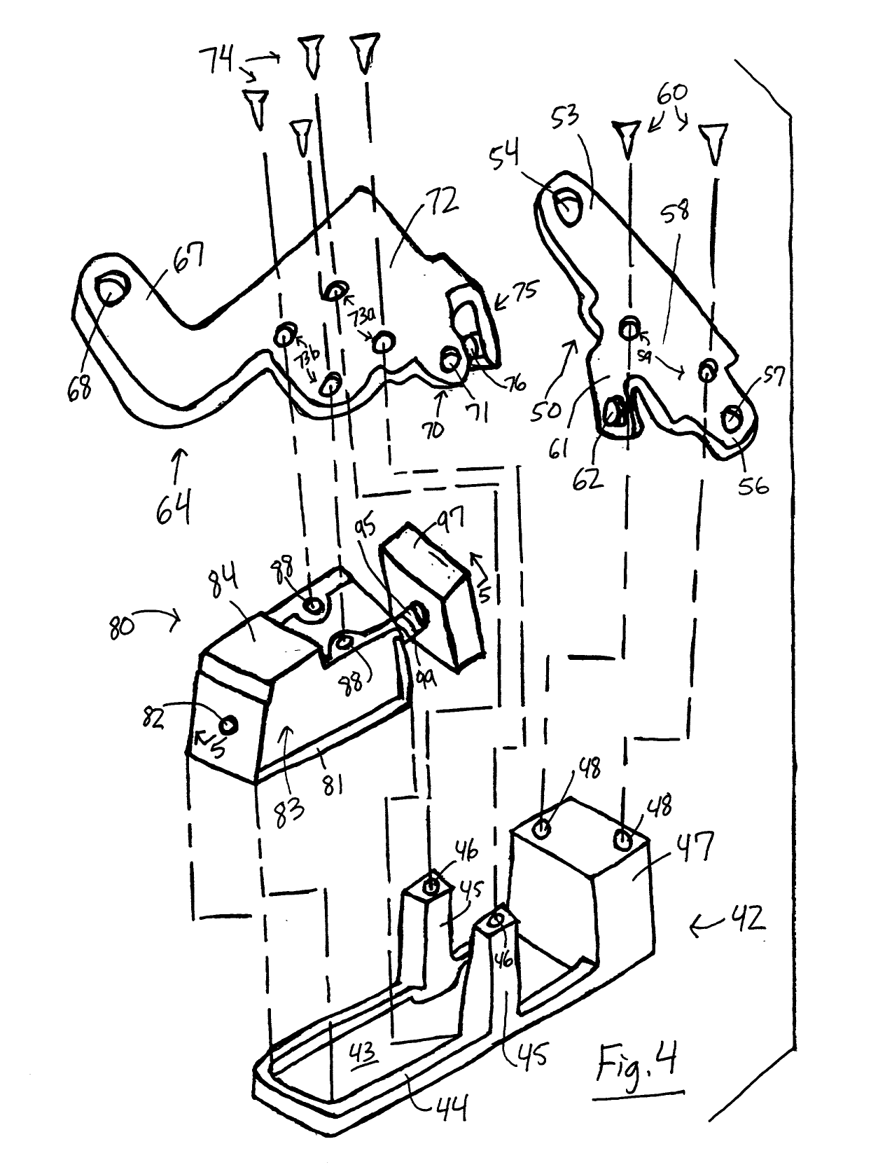

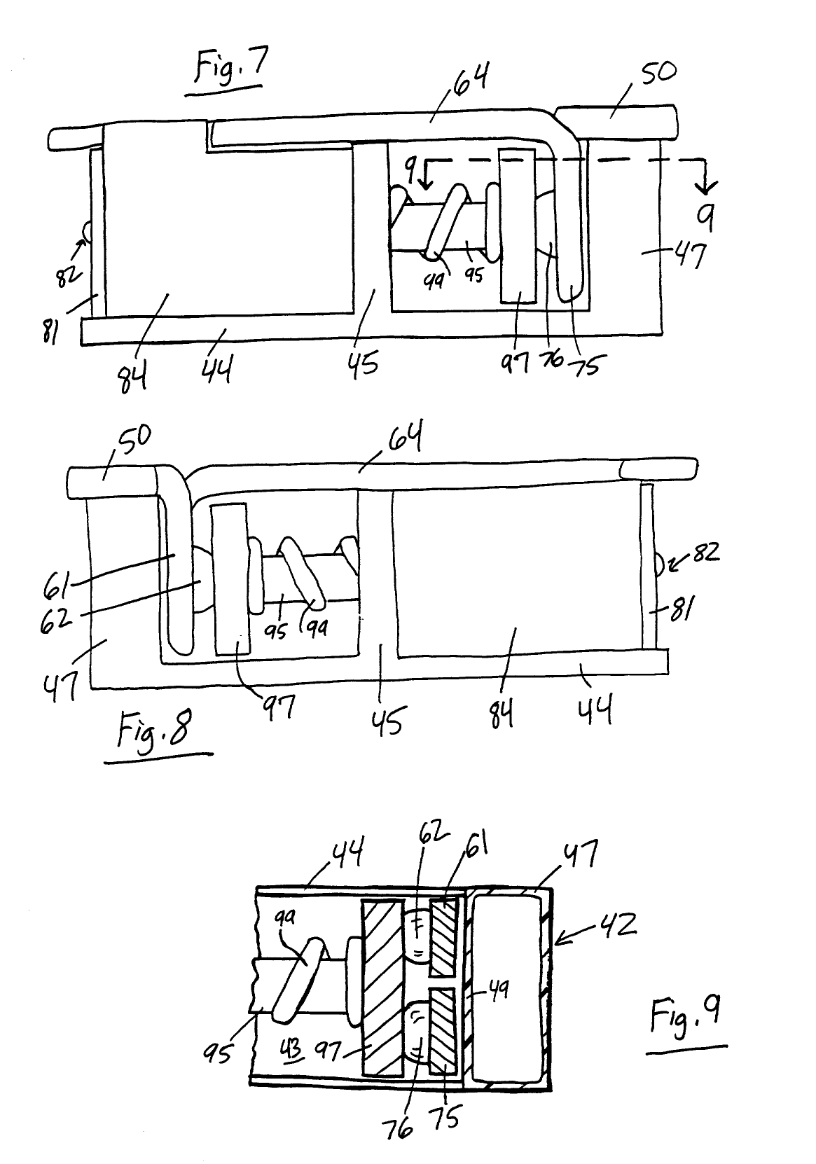

Referring to FIGS. 4 to 9, the construction of the switch assembly 40 can be seen. The switch assembly 40 broadly comprises a switch mounting base 42, the relay 80, the first conductive buss bar 50, the second conductive buss bar 64, and assembly fasteners 60 and 74. The mounting base 42 is preferably molded from a polymeric material and has mounting posts 45, side rails 44 and a mounting upright 47 that all extend upward from a floor 43. The mounting posts 45 include mounting holes 46 which are typically internally threaded to accept externally threaded fasteners 74. Alternatively, the externally threaded fasteners 74 may be self-tapping screws such that the mounting holes 46 are not required in the mounting posts 45. The mounting upright 47 also includes mounting holes 48 which are typically internally threaded to accept externally threaded fasteners 60. Alternatively, the externally threaded fasteners 60 may be self-tapping screws such that the mounting holes 48 are not required in the mounting upright 47.

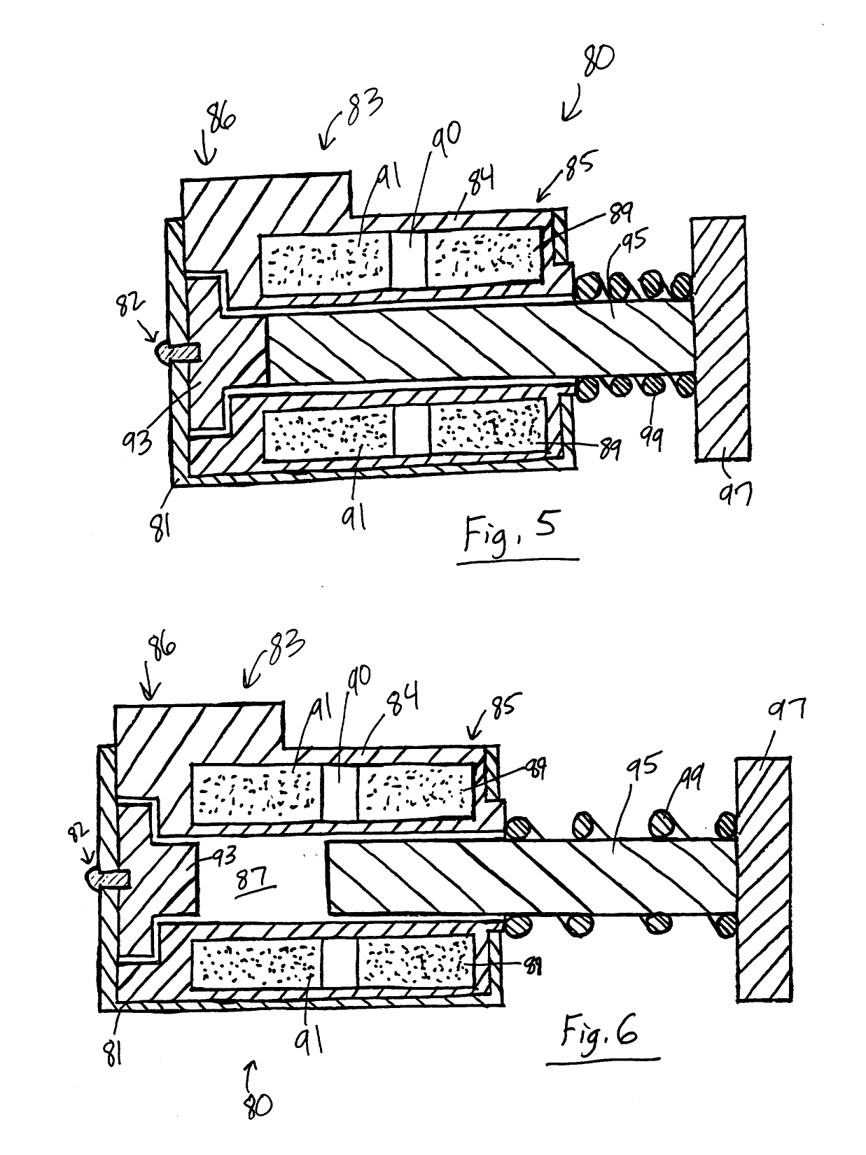

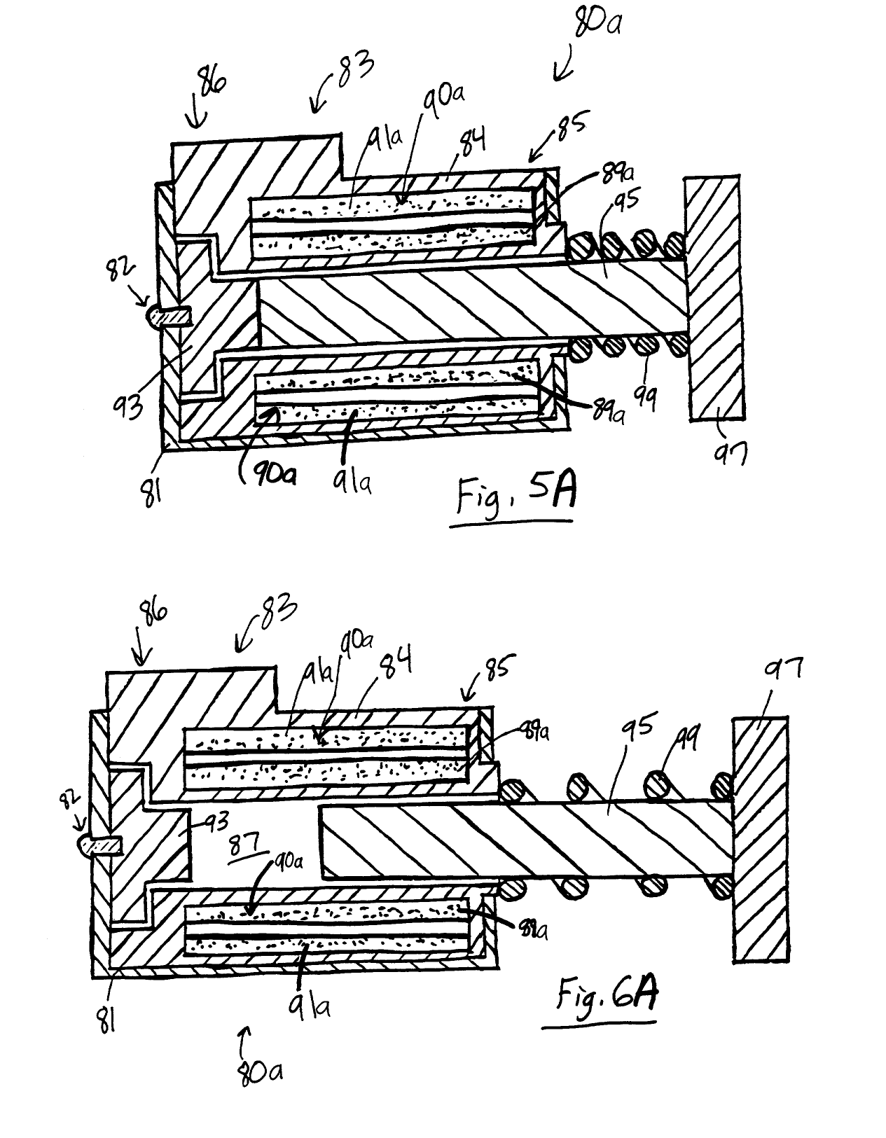

FIGS. 5 and 6 illustrate the relay 80 that is advantageously used in the switch assembly 40. The relay 80 broadly comprises a coil assembly 83, a plunger 95, a spring 99, and a buss bar 97. The coil assembly 83 of the relay 80 comprises a substantially cylindrical plastic housing 84 mounted on a steel frame 81. The housing 84 contains a coil 90 having a front winding 89 (comprising a first winding) and rear winding 91 (comprising a second winding) which are wound in opposite directions. The coil 90 including the front winding 89 and the rear winding 91 is encapsulated within the housing 84, which is preferable formed from polyester. In one form, the coil 90 may have a coil resistance of 1.05/1.26 ohms±5% at 25° C. The housing 84 includes an integral front end 85 near the front winding 89 and an integral rear end 86 near the rear winding 91. The front winding 89 and the rear winding 91 are placed in electric communication with the controller 32 by way of three wires (not shown). A first common wire is connected to a common section of the coil 90 wherein the front winding 89 and the rear winding 91 meet; a second wire is connected to the front winding 89; and a third wire is connected to the rear winding 91. The front winding 89 and the rear winding 91 of the coil 90 are wound in opposite directions in order to create magnetic fields of opposite directions when the front winding 89 and the rear winding 91 are energized by electric current.

FIGS. 5A and 6A illustrate another relay 80a that may be advantageously used in the switch assembly 40. The relay 80a broadly comprises a coil assembly 83, a plunger 95, a spring 99, and a buss bar 97. The coil assembly 83 of the relay 80a comprises a substantially cylindrical plastic housing 84 mounted on a steel frame 81. The housing 84 contains a coil 90a having an inner winding 89a (comprising a first winding) and an outer winding 91a (comprising a second winding) which are wound in opposite directions. The coil 90a including the inner winding 89a and the outer winding 91a is encapsulated within the housing 84, which is preferable formed from polyester. In one form, the coil 90a may have a coil resistance of 1.05/1.26 ohms±5% at 25° C. The housing 84 includes an integral front end 85 near the front of coil windings 89a and 91a and an integral rear end 86 near the rear of coil windings 89a and 91a. The inner winding 89a and the outer winding 91a are placed in electric communication with the controller 32 by way of three wires (not shown). A first common wire is connected to a common section of the coil 90a wherein the inner winding 89a and the outer winding 91a meet; a second wire is connected to the inner winding 89a; and a third wire is connected to the outer winding 91a. The inner winding 89a and the outer winding 91a of the coil 90a are wound in opposite directions in order to create magnetic fields of opposite directions when the inner winding 89a and the outer winding 91a are energized by electric current.

In the relays 80 and 80a shown in FIGS. 5, 5A, 6, and 6A, an interior cylindrical passageway 87 is defined by the housing 84. The plunger 95, which may be formed from steel, is slidably disposed within the interior of the coil 90 or 90a in the passageway 87. The plunger 95 extends axially through the passageway 87 and the interior of the biasing spring 99 that is arranged between a front surface of the housing 84 and the buss bar 97, which is attached to the front end of the plunger 95. The buss bar 97 is preferably formed from copper or a copper alloy and may be silver plated for additional conductivity. In an example embodiment of the invention, the buss bar 97 is made from copper alloy CDA 110 and has the dimensions of 0.620″×0.820″×0.250″. At the rear portion of the housing 84 in the end of the passageway 87, there is mounted a magnetic backstop 93 that is held in position by an backstop fastener 82 positioned in a hole in the frame 81. The magnetic backstop 93 may include a permanent magnet adjacent the frame 81. When the switch assembly 40 is assembled, the relay 80 or 80a rests on the floor 43 of the mounting base 42 such that the housing 84 of the relay 80 or 80a is positioned on one side of the mounting posts 45 of the mounting base 42, the plunger 95 of the relay 80 is positioned between the mounting posts 45, and the buss bar 97 is positioned on an opposite side of the mounting posts 45. Also, the mounting base 42 is preferably configured with a perimeter and height such that the mounting base 42 and relay 80 or 80a can fit within the inner volume of a cell cavity 13 above the set of cell plates and below the cover well cover plate 17.

Having described the construction of the relay 80 or 80a, the operating positions of the relay 80 or 80a can be seen by reference to FIGS. 5, 5A, 6 and 6A. FIGS. 5 and 5A show the relay 80 or 80a in its withdrawn or open position, in which the plunger 95 is at its point of minimum extension through the front end 85 of the housing 84. In the open position, the plunger 95 is at the rearward extreme of its range of motion, with the biasing spring 99 compressed. When the plunger 95 is in a retracted position as shown in FIGS. 5 and 5A, the rear portion of the plunger 95 is typically seated against the magnetic backstop 93 that is mounted in the rear end 86 of the housing 84. The magnetic force of the backstop 93 keeps the plunger 95 latched in its retracted position. The configuration of the relay 80 or 80a in its extended or closed position is illustrated in FIGS. 6 and 6A. When the plunger 95 is in an extended position as shown in FIGS. 6 and 6A, the plunger 95 is latched in the forward position by the biasing force of spring 99 against the front of the housing 84 and the buss bar 97.

The first conductive buss bar 50 of the switch assembly 40 is best shown in FIG. 4. The first conductive buss bar 50 is preferably formed from a highly conductive material, such as copper, and may be silver plated for additional conductivity. The first conductive buss bar 50 has a first end portion 53, a central portion 58, and a second end portion 56. The first end portion 53 has a mounting hole 54 for securing the first buss bar 50 in electrical communication with the connector 26 with the fastener 55 as described above. The second end portion 56 of the first buss bar 50 has a mounting hole 57 for securing the first buss bar 50 in electrical communication with the controller 32 with a fastener 57a (shown in FIG. 2). The central portion 58 of the first buss bar 50 has a downwardly extending tab 61 that is substantially perpendicular to the upper surface of the central portion 58 of the first buss bar 50. At the lower end of the tab 61, there is attached a first contact 62 that is preferably formed from a highly conductive material, such as copper, and may be silver plated and coated with silicone grease for additional conductivity. In an example embodiment of the invention, the first contact 62 is made from copper alloy CDA 102 and has a 0.375″ diameter and extends 0.125″ outward from the tab 61. The central portion 58 of the first buss bar 50 is secured to an upper surface of the upright 47 of the mounting base 42 of the switch assembly 40 by fasteners 60 which extend through mounting holes 59 in the first bus bar 50 and into mounting holes 48 in the upright 47 of the base 42.

The second conductive buss bar 64 of the switch assembly 40 is also best shown in FIG. 4. The second conductive buss bar 64 is preferably formed from a highly conductive material, such as copper, and may be silver plated for additional conductivity. The second conductive buss bar 64 has a first end portion 67, a central portion 72, and a second end portion 70. The first end portion 67 has a mounting hole 68 for securing the second buss bar 64 in electrical communication with the positive terminal 18 with the fastener 69 as described above. The second end portion 70 of the second buss bar 64 has a mounting hole 71 for securing the second buss bar 50 in electrical communication with the controller 32 with a fastener 71a (shown in FIG. 2). The central portion 72 of the second buss bar 64 has a downwardly extending tab 75 that is substantially perpendicular to the upper surface of the central portion 72 of the second buss bar 64. At the lower end of the tab 75, there is attached a second contact 76 that is preferably formed from a highly conductive material, such as copper, and may be silver plated and coated with silicone grease for additional conductivity. In an example embodiment of the invention, the second contact 62 is made from copper alloy CDA 102 and has a 0.375″ diameter and extends 0.125″ outward from the tab 75. The central portion 72 of the second buss bar 64 is secured to upper surfaces of the mounting posts 45 of the mounting base 42 of the switch assembly 40 by fasteners 74 which extend through mounting holes 73a in the second bus bar 64 and into mounting holes 46 in the mounting posts 45 of the base 42. The central portion 72 of the second buss bar 64 is also secured to an upper surface of the housing 84 of the relay 80 or 80a of the switch assembly 40 by fasteners 74 which extend through mounting holes 73b in the second bus bar 64 and into mounting holes 88 in the upper surface of the relay 80 or 80a of the switch assembly 40.

Having described the construction of the relay 80 or 80a, and the assembly of the switch mounting base 42, the relay 80 or 80a, the first conductive buss bar 50, and the second conductive buss bar 64 into the switch assembly 40, the configuration of the relay 80 or 80a, the first conductive buss bar 50, and the second conductive buss bar 64, in the normally closed position of the switch assembly 40 can be described with reference to FIGS. 7 to 9. Looking at FIGS. 7 to 9, the switch assembly 40 is shown in its normally closed position in which the plunger 95 of the relay 80 or 80a is in the extended position. When the first conductive buss bar 50 and the second conductive buss bar 64 are assembled to the mounting base 42 of the switch assembly 40 as described above, the tab 61 of the first conductive buss bar 50 and the tab 75 of the second conductive buss bar 64 are aligned in substantially parallel relationship adjacent an inside wall 49 of the upright 47 of the base 42. As a result, the contact surface of the first contact 62 of the first conductive buss bar 50 and the contact surface of the second contact 76 of the second conductive buss bar 64 are aligned in substantially parallel spaced apart relationship as shown in FIG. 9. It can be appreciated that the tab 61 of the first conductive buss bar 50 and the tab 75 of the second conductive buss bar 64 are dimensioned and positioned such that the tab 61 and the tab 75 are positioned within the perimeter of the side rails 44 of the mounting base 42 so that the first contact 62 and the second contact 76 fit within the inner volume of a cell cavity 13 above the set of cell plates and below the cover well cover plate 17. When the plunger 95 of the relay 80 or 80a is in the extended position, the buss bar 97 of the relay 80 or 80a contacts the first contact 62 of the first conductive buss bar 50 and the second contact 76 of the second conductive buss bar 64.

Looking at FIGS. 2, 7, 8 and 9, it can be seen that in the battery 10, current flows from the positive plates 30 through the cell post 24 into the connector 26. From the connector 26, the current flows into the first end portion 53 of the first buss bar 50 and then into the central portion 58 of the first buss bar 50. From the central portion 58 of the first buss bar 50, current flows into the downward tab 61 and into the first contact 62. From the first contact 62, current flows into the buss bar 97 of the relay 80 or 80a and into the second contact 76. Preferably, the buss bar 97 is formed such that the switch assembly 40 will exhibit a resistance between first contact 62 and second contact 76 of about 0.3 milliohms or less at currents of 200 amps or above. In addition, it has been discovered that a relay buss bar mass of about 5 grams (for a copper or a copper alloy buss bar) is required in order to keep the temperature of the relay buss bar at or below 100° C. during high current flows of 800 amps or greater. From the second contact 76, current then flows into the downward tab 75 of the second buss bar 64. From the downward tab 75 of the second buss bar 64, current flows into the central portion 72 of the second buss bar and into from the first end portion 67 of the second buss bar 64 and into the positive terminal 18. Of course, when the plunger 95 of the relay 80 or 80a retracts, the current path between the first contact 62 and the second contact 76 provided by the buss bar 97 of the relay 80 or 80a is interrupted thereby preventing current flow from the battery 10 to the positive terminal 18. As a result, electrical power is not provided to the starter circuit 36, the alternator 35 and the electrical accessories 34 as shown in FIG. 10.

It can now be appreciated that the relay 80 or 80a controls the making or breaking of a circuit path between the first contact 62 and the second contact 76. Looking at FIGS. 5 to 9, the operation of the relay 80 or 80a can be explained further. In the normally closed position of the relay 80 or 80a, the spring 99 biases the plunger 95 and the attached buss bar 97 toward the first contact 62 and the second contact 76 such that the plunger 95 and the attached buss bar 97 are latched in a closed position in which the buss bar 97 contacts the first contact 62 and the second contact 76. When the controller 32 determines that the circuit path between the first contact 62 and the second contact 76 should be interrupted (as will be described below), the controller 32 allows an electrical current from the battery 10 to energize rear winding 91 of the relay 80 or the outer winding 91a of the relay 80a causing the plunger 95 to move rearward against the bias of the spring 99 and toward the magnetic backstop 93. When the plunger has reached a position near the magnetic backstop 93, the magnetic backstop 93 latches the plunger 95 in its rearward (open) position. When the controller 32 determines that the circuit path between the first contact 62 and the second contact 76 should be restored (as will be described below), the controller 32 allows an electrical current from the battery 10 to energize the front winding 89 or the inner winding 89a. Energization of the front winding 89 or the inner winding 89a draws the plunger 95 forward in the passageway 87 and away from the magnetic backstop 93. The spring 99 also assists in moving the plunger 95 into the forward (extended) position. The spring 99 then biases the plunger 95 and the attached buss bar 97 toward the first contact 62 and the second contact 76 such that the plunger 95 and the attached buss bar 97 are latched in a closed position in which the buss bar 97 contacts the first contact 62 and the second contact 76.

The controller 32 can open and close the relay 80 or 80a according to any number of control schemes. For example, the controller 32 may comprise a control system such as the vehicle anti-theft system shown and described in U.S. Pat. Nos. 5,965,954 and 5,977,654, which are owned by the assignee of the present invention and are incorporated herein by reference as if fully set forth herein. In the anti-theft system of U.S. Pat. Nos. 5,965,954 and 5,977,654, a microprocessor, which can be a suitable combination of hardware, software and discrete components, determines an engine running status, an engine started recently status, a driver entry status, an anti-theft system armed/disarmed status, and an unauthorized vehicle start status, and when certain conditions are met, the microprocessor provides control signals to other electrical devices in the battery.

The anti-theft system described in U.S. Pat. Nos. 5,965,954 and 5,977,654 can be incorporated into the control 32 of the present invention in order to control operation of the relay 80 or 80a. For instance, the anti-theft system can be placed in an armed state by a fob transmitter that transmits a signal to a receiver in the anti-theft system. When in an armed state, the anti-theft system can detect an unauthorized start of the engine, and the controller 32 can provide an electrical signal to the relay 80 or 80a of the present invention to open the relay 80 or 80a as described above and thereby disconnect battery power from the vehicle electrical system 11 as shown in FIG. 10.

Of course, the controller 32 of the present invention is not limited to systems such as the anti-theft system shown in U.S. Pat. Nos. 5,965,954 and 5,977,654. Any control system which can provide energizing electric currents to the front winding 89 and the rear winding 91 of the coil 90 of the relay 80 or to the inner winding 89a and the outer winding 91a of the coil 90a of the relay 80a to move the plunger 95 of the relay 80 or 80a would be suitable for use in the present invention. The specific circumstances in which the energizing currents are supplied from the controller 32 to the front winding 89 and the rear winding 91 of the coil 90 of the relay 80 or to the inner winding 89a and the outer winding 91a of the coil 90a of the relay 80a can vary depending on the logic built into controller 32.

Although many specific control systems can be incorporated into the controller 32 to move the plunger 95 of the relay 80 or 80a, it is particularly advantageous to employ in the battery 10 a controller 32 that provides electrical pulses to the front winding 89 and the rear winding 91 of the coil 90 of the relay 80 or to the inner winding 89a and the outer winding 91a of the coil 90a of the relay 80a to move the plunger 95. As detailed above, the plunger 95 of the relay 80 or 80a is latched into a normally closed, forward position (as shown in FIGS. 6 and 6A) during typical operation of the battery 10. When the controller 32 detects a condition which warrants opening the relay 80 or 80a (such as an unauthorized start when an anti-theft system is armed as described in U.S. Pat. Nos. 5,965,954 and 5,977,654), the controller 32 sends an electrical pulse to the rear winding 91 of the relay 80 or to the outer winding 91a of the relay 80a causing the plunger 95 to move rearward to its open position as described above. The magnetic backstop 93 then latches the plunger 95 in its rearward (open) position without the need for continued application of an electrical current from the controller 32 to the rear winding 91 of the relay 80 or the outer winding 91a of the relay 80a. It can be appreciated that the single electrical pulse from the controller 32 that moves the plunger 95 into a rearward (open) latched position consumes very little charge from the battery 10. Pulse signals of 1 second or less, and preferably 100 milliseconds, are suitable for moving the plunger 95 into a rearward (open) latched position. High currents can also be used for the pulse signals as heat generation is minimized. In prior switching devices, a continuous supply of current is typically required to keep a relay in an open position. These prior switching devices are quite disadvantageous in that a continuous drain on the battery is necessary to supply current to the switch. In a similar manner, when the controller 32 detects a condition which warrants moving the plunger 95 of the relay 80 or 80a back into its closed position (such as a disarming of an anti-theft system after an unauthorized start as described in U.S. Pat. Nos. 5,965,954 and 5,977,654), the controller 32 sends an electrical pulse, preferably having a duration of 1 second or less, to the front winding 89 of the relay 80 or to the inner winding 89a of the relay 80a causing plunger 95 to move forward to its closed position as described above. Continued application of an electric current to the front winding 89 of the relay 80 or to the inner winding 89a of the relay 80a is not required as the plunger 95 is latched into its forward position as described above. Therefore, it can be seen that the switch assembly 40 and the controller 32 can: (1) create a circuit path between the cell post 24 and the positive terminal 18, or (2) open the circuit path, without the need for a continuous supply of electricity to the relay 80 or 80a. As a result, the switch assembly 40 drains minimal current from the battery when the switch assembly is in an open or closed position. This is particularly advantageous in that a vehicle can sit for long periods without the possibility of the switch assembly 40 draining the battery 10.

The switch assembly 40 is also particularly advantageous in that it has a very low resistance. As detailed above in the Background of the Invention section, anti-theft battery switches that add significant resistance to the circuit path from battery cells to a battery terminal are problematic in that cold cranking performance ratings are adversely affected. The switch assembly 40 according to the invention provides for very low resistance and therefore, a battery manufacturer would not be reluctant to incorporate the switch assembly 40 into a battery as the published cold cranking amps rating for a battery would not be significantly affected. In order to determine the resistance of a switch assembly 40 according to the invention, the following tests described in Examples 1A. 1B and 2 were performed. These tests demonstrate that a switch assembly 40 according to the invention will exhibit a resistance between the first contact 62 and the second contact 76 of about 0.3 milliohms or less at currents of 200 amps or above. This low level of resistance has been shown to not adversely affect cold cranking test performance ratings.

### Example 1A

### Switch Contact Resistance Measurement

Twenty-eight switch assemblies in accordance with the present invention were constructed. A current of 200 amps was passed for 60 seconds through the first buss bar 50, the first contact 62, the buss bar 97 of the relay, the second contact 76 and the second buss bar 64. The voltage drop across the first contact 62 and the second contact 76 was then measured. The voltage drop across the contacts was then divided by 200 (i.e., 200 amps) to determine the resistance between the contacts. The average resistance measurement for the twenty-eight switch assemblies between contacts was 0.14±0.024 milliohms.

### Example 1B

### Switch Contact Resistance Measurement

A current of 600 amps was then passed through the twenty-eight switch assemblies as described in Example 1A and the voltage drop measured across the contacts was then divided by 600 (i.e., 600 amps) to determine the resistance between the contacts. The average resistance for the twenty-eight switch assemblies between contacts was 0.15±0.025 milliohms.

### Example 2

### Battery Cold Cranking Test Simulation

Six switch assemblies in accordance with the present invention were constructed. The switch assemblies were placed in an 0° F. (−18° C.) environment for at least 6 hours. A current of 900 amps was then passed for 45 seconds through the switch assemblies as in Examples 1A and 1B. The voltage drop across the first and second contacts was then measured. The voltage drop across the contacts was then divided by 900 (i.e., 900 amps) to determine the resistance between the contacts. The same 900 amp current was then passed for 45 seconds through the switch assemblies for a second time. The results of the twelve tests showed a resistance between contacts ranging from 0.102 milliohms to 0.139 milliohms.

### Example 3

### Temperature Resistance of the Buss Bar of the Relay

A computer simulation was performed to determine the mass of the relay buss bar according to the invention that will provide acceptable performance under the high currents present during vehicle starting. It was determined that a relay buss bar temperature in excess of 100° C. was unacceptable during vehicle starting as the buss bar could experience physical damage under the high temperatures.

The projected temperature rise for different masses of copper alloy (CDA 110) relay buss bars was calculated using a simulated cold crank test having current and duration values of 800 amps for 45 seconds. These values were selected to fall within the range of cold cranking amps expected from a premium vehicle battery as detailed in the Background of the Invention section above. It was discovered that a relay buss bar mass of about 5 grams is required in order to keep the temperature of the relay buss bar at or below 100° C. during an 800 amp cold crank test that lasted 45 seconds.

Therefore, it can be seen that there has been disclosed an anti-theft battery switch that has a single circuit path between the battery and the vehicle starter and accessories, that can be latched into an open or closed position without the need for a continuous supply of electric current, that has a low resistance, that can withstand the high discharge currents used in battery performance tests, and that can be fitted into existing battery containers.

Although the present invention has been described in considerable detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein.

What is claimed is:

1. A battery for supplying electric power to a starter motor and to electrical loads in a vehicle, the battery comprising:
a battery casing including a container and a cover, the casing having an external positive terminal and an external negative terminal, and the container having a plurality of cell cavities;
a battery cell disposed in each cell cavity, each battery cell containing at least one negative plate, at least one positive plate, and a separator between adjacent negative and positive plates, the battery cells being serially connected;
a first circuit path between one of the negative or positive terminal and a first set of plates of common polarity in one battery cell;
a second circuit path between the other of the positive or negative terminal and a second set of plates of opposite common polarity in another battery cell, the second circuit path being the only electrical path between the second set of plates and the other of the positive or negative terminal;
a switch arranged in the second circuit path, the switch having a normally closed position and an open position, the switch moving into the open position in response to a control signal; and
a controller in electrical communication with the battery and the switch for providing the control signal to the switch to move the switch into the open position.

2. The battery of claim 1 wherein:
the controller includes an anti-theft circuit having an armed state and a disarmed state, and
the controller provides the control signal to the switch to move the switch into the open position when the vehicle is started while the anti-theft circuit is in the armed state.

3. The battery of claim 1 wherein the second circuit path comprises:
a cell post connected to the second set of plates;
a first buss bar connected to the cell post; and
a second buss bar connected to the other of the positive or negative terminal,
wherein the switch comprises an electromechanical switch including a third buss bar such that when the switch is in the closed position, the third buss bar places the first buss bar and the second buss bar in electrical communication.

4. The battery of claim 3 wherein:
the first buss bar, the second buss bar and the switch are housed in the cover.

5. The battery of claim 3 wherein:
the switch is dimensioned to fit within the inner volume of a cell cavity above a battery cell and below a top surface of the cover.

6. The battery of claim 3 wherein:
the third buss bar is formed from a copper alloy and is configured to keep the temperature of the third buss bar at or below 100° C. during current flows of 800 amps or greater.

7. The battery of claim 3 wherein:
the first buss bar includes a first contact,
the second buss bar includes a second contact, and
the third buss bar contacts the first contact and the second contact when the switch is in the closed position.

8. The battery of claim 7 wherein:
the electrical resistance as measured between the first contact and the second contact when the third buss bar contacts the first contact and the second contact in the closed position of the switch is less than 0.3 milliohms at 200 amps or greater current.

9. The battery of claim 7 wherein:
a contact surface of the first contact and a contact surface of the second contact are positioned in parallel spaced apart relationship.

10. The battery of claim 3 wherein the switch comprises a latching relay including:
a housing containing a coil having a first winding and a second winding, and a magnetic backstop at a rear end of the housing, the first winding and the second winding of the coil being in electrical communication with the controller,
a plunger slidably disposed between a first axial position and a second axial position within the interior of the coil, the third buss bar being mounted to the plunger, and
a spring for biasing the third buss bar away from the magnetic backstop and into contact with the first buss bar and the second buss bar,
wherein the plunger is moved toward the magnetic backstop against the biasing force of the spring and into a latched position when the first winding of the coil is energized by a first switch control signal from the controller, and wherein the plunger is moved away from the magnetic backstop and the third buss bar is placed back into latched contact with the first buss bar and the second buss bar when the second winding of the coil is energized by a second switch control signal from the controller.

11. The battery of claim 10 wherein:
the first switch control signal and the second switch control signal are pulse signals.

12. The battery of claim 11 wherein:
the first switch control signal and the second switch control signal have a pulse duration of one second or less.

13. A switch for controlling the supply of current from a battery cell in a cell cavity to a battery terminal in a battery casing, the switch comprising:
a mounting base;
a first buss bar connected to the mounting base, the first buss bar being suitable for connection to the battery cell;
a second buss bar connected to the mounting base, the second buss bar being suitable for connection to the battery terminal; and
a relay having an open position and a closed position, the relay including a third buss bar such that when the relay is in the closed position, the third buss bar places the first buss bar and the second buss bar in electrical communication.

14. The switch of claim 13 wherein:
the mounting base and the relay are dimensioned to fit within the inner volume of the cell cavity above the battery cell and below a top surface of a battery cover.

15. The switch of claim 13 wherein:
the third buss bar is formed from a copper alloy and is configured to keep the temperature of the third buss bar at or below 100° C. during current flows of 800 amps or greater.

16. The switch of claim 13 wherein:
the first buss bar includes a first contact having a first contact surface,
the second buss bar includes a second contact having a second contact surface,
the first contact surface of the first contact and the second contact surface of the second contact are positioned in parallel spaced apart relationship, and
the third buss bar contacts the first contact surface and the second contact surface when the relay is in the closed position.

17. The switch of claim 16 wherein:
the electrical resistance as measured between the first contact and the second contact when the third buss bar contacts the first contact surface and the second contact surface in the closed position of the relay is less than 0.3 milliohms at 200 amps or greater current.

18. The switch of claim 13 wherein the relay comprises:
a housing containing a coil having a first winding and a second winding, and a magnetic backstop at a rear end of the housing, the first winding and the second winding of the coil being suitable for connection to a source of electric current,
a plunger slidably disposed between a first axial position and a second axial position within the interior of the coil, the third buss bar being mounted to the plunger, and
a spring for biasing the third buss bar away from the magnetic backstop and into contact with the first buss bar and the second buss bar,
wherein the plunger is moved toward the magnetic backstop against the biasing force of the spring and into a latched open position when the first winding of the coil is energized by electric current, and wherein the plunger is moved away from the magnetic backstop and the third buss bar is placed back into a latched closed position in contact with the first buss bar and the second buss bar when the second winding of the coil is energized by electric current.

19. The switch of claim 18 wherein:
the plunger is moved into the latched open position by application of a first pulse signal and the plunger is moved back into latched closed position by application of a second pulse signal.

20. The switch of claim 19 wherein:
the first pulse signal and the second pulse signal have a pulse duration of one second or less.
